(19) United States
(12) Patent Application Publication
(10) Pub. No.: US 2026/0300127 A1
(43) Pub. Date: Oct. 1, 2026

(54) SYSTEM FOR DETERMINING UPGRADE DEPLOYMENT COMPATIBILITY

(71) Applicant: T-Mobile USA, Inc., Bellevue, WA (US)

(72) Inventor: Shiji Mathew Enchakilodil, Bellevue, WA (US)

(21) Appl. No.: 19/095,392

(22) Filed: Mar. 31, 2025

(51) Int. Cl. G06F 11/3604

(52) U.S. Cl. CPC G06F 11/3608

(57) ABSTRACT

A system configured to generate a digital twin of operations of a communications network. The digital twin may be utilized to simulate deployment of upgrades to various hardware of the network. In this manner, the digital twin may be utilized to determine if expected operations or potential issues may result from the deployment prior to taking hardware offline for the upgrade deployment.

### BACKGROUND

Today, companies or organizations periodically invest in and install software upgrades to their systems. However, companies and/or organizations with multiple sites often deploy hardware at different locations with varied capabilities, components, and/or the like. Additionally, over time the disparate hardware at various sites often undergoes repairs, maintenance, and the like at different times and using different techniques, equipment, and components. As a result, when software upgrades are deployed across sites, the results and outcomes may differ from location to location.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a system for generating a digital twin of a network and executing simulations associated with the digital twin, according to some implementations.

FIG. 2 is another example block diagram of a system for generating a digital twin of a network, according to some implementations.

FIG. 3 is a flow diagram illustrating an example process associated with a system for evaluating upgrade deployments using a digital twin of a network, according to some implementations.

FIG. 4 is another flow diagram illustrating an example process associated with a system for evaluating upgrade deployments using a digital twin of a network, according to some implementations.

FIG. 5 is an example system that may implement the techniques described herein according to some implementations.

### DETAILED DESCRIPTION

Discussed herein are systems for evaluating upgrades, such as software modifications or changes, to a network having hardware located at multiple locations, at various life stages, and having undergone various repairs and/or maintenance operations. Accordingly, the network may have sites or nodes that have differing capabilities, characteristics, and/or hardware components. In conventional systems, the upgrades may be applied on a site by site basis and, often, result in the site being taken offline or otherwise unavailable for a number of days while the upgrade is being deployed. Unfortunately, in some cases, a particular site with particular hardware may experience an issue or unexpected consequence of the upgrade, resulting in the site being down for additional periods of time, such as to revert the site or node back to the original state and/or to debug the particular issue of the particular site. In these cases, not only is the site or node unavailable during the deployment period, the node or site may also be unavailable for an additional period of time for the disrupting network services.

The system discussed herein may be configured to generate a digital twin or virtual twin of the network that may be simulated via one or more server systems and/or cloud computing systems. As discussed herein, the digital twin may be a digital replica of the operations of the network including hardware operations and or software operations associated with one or more sites or nodes of the network that may be emulated or simulated in a virtual environment (e.g., via one or more servers). In some cases, the digital twin may be a virtual representation of a physical network including hardware, software, and components that may be continuously updated in substantially real-time to replicate any modifications to the physical network.

In this manner, the digital twin of the network may operate as a standalone virtual network that may be used to simulate results of various upgrade operations that may be performed with respect to the physical network. In this example, the digital twin may be used to simulate operations of the entire network and/or individual sites of the network, as well as individual hardware components of the network. In some specific examples, the digital twin may be utilized to simulate modifications and/or upgrades to the entire network, the individual sites or nodes, and/or the individual hardware components prior to deployment on the physical systems.

In some cases, the digital twin may be generated using first one or more machine learning models or networks that receive as an input one or more snapshots captured at various periods of time of the operational status and state of each of the sites or nodes of the network. For example, the network may be configured to capture one or more snapshots on a periodic basis (e.g., daily, weekly, monthly, and the like) or in response to one or more triggers (e.g., upon user request, in response to a network condition, and/or the like).

In some implementations, the one or more first machine learning models or networks may also receive, as an input, maintenance logs, upgrade logs, and/or hardware related data. For example, the system may receive data associated with upgraded hardware at one or more sites or nodes, components associated with maintenance operations or repair operations associated with hardware of one or more sites or nodes, currently occurring issues or performance degradations associated with hardware of one or more sites or nodes, and/or the like.

In some specific examples, the first machine learning models maybe trained based on network data, prior upgrade data, hardware data, maintenance log data, repair operation data, and/or the like, generated with respect to various sites or nodes equipped with various components and hardware. In some cases, the training may incorporate data collected over various periods of time (such as snapshots captured over prior days, months, years and/or the like) to generate or update the digital twin at the various intervals or with respect to newly generated data (such as a new snapshot of the network, site, or node).

In some cases, the system may also include one or more second machine learned models or networks that may be trained to simulate the operation of the network via one or more digital twins (e.g., such as based on one or more snapshots, representing one or more sites or nodes or groups of sites or nodes, and/or the like) and data associated with a planned upgrade deployment. In this manner, prior to deployment of a planned software upgrade on hardware at various sites or nodes that have undergone various repair operations and utilize various different types of hardware, the digital twin system may be utilized to detect issues or operational degradations for each individual site and/or hardware component of the network prior to physical deployment.

In some specific examples, the second machine learning models maybe trained based on simulation data (both input and output) performed on various versions or positions of digital twins or virtual models of the network. In some cases, the training data may be synthetic or computer generated (e.g., generated by one or more models and associated with upgrades that may not necessarily have been deployed ot a physical location, site or node).

In the current implemention, executing a simulation of the digital twin as if the software upgrades were deployed for a period of time and a virtual environment may allow the system to determine if the network and/or individual sites or nodes are operating outside one or more operational thresholds following the deployment. For example, the one or more operational thresholds may be determined by the system by executing a first simulation of the digital twin prior to the deployment. The system may then compare results associated with the first simulation (e.g., the digital twin prior to deployment) with results associated with a second simulation post deployment to determine if the variation in operations resulted. In some cases, the system may utilize a simulation of the digital twin prior to deployment together with one or more expected results or modifications of the operations resulting from the software deployment to determine the one or more operational thresholds. In one specific example, the results of the simulation may be utilized to determine if the upgrade deployment resulted in one or more improved operational metrics, such as, but not limited to, increased bandwidth, throughput, signal strength, signal-to-noise ratios, received signal strength indicators, coverage area, and/or the like or reduced latency, jitter, packet loss, error rates, interference, customer experience, speed leadership, capex or opex reduction, coverage area, downtime, and/or the like as experienced by devices that are serviced by the network.

In various examples, if the system determines the deployment will cause an issue with one or more specific site or node, the system may alert an operator (e.g., such as a software engineer) to the detected issue. In this manner, the operator may be able to debug the issue with a particular site prior to deployment at that site. For instance, the system may approve or greenlight deployment of the upgrade at one or more first sites or nodes that did not experience issue (e.g., sites or nodes that pass the simulation) while halting or holding deployment of the upgrade at one or more second sites or nodes that did experience an issue (e.g., sites or nodes that failed the simulation). In this manner the system may allow for deployment of upgrades in an efficient and effective manner while preventing upgrades to sites or nodes that may experience an issue until an operator, such as a software engineer or field operations engineer, debugs or otherwise compensates for the particular issue at each site or node experiencing an issue related to the deployment.

As described herein, the machine learning models or networks may be generated using various machine learning techniques. For example, the models may be generated using one or more neural network(s). A neural network may be a biologically inspired algorithm or technique which passes input data through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

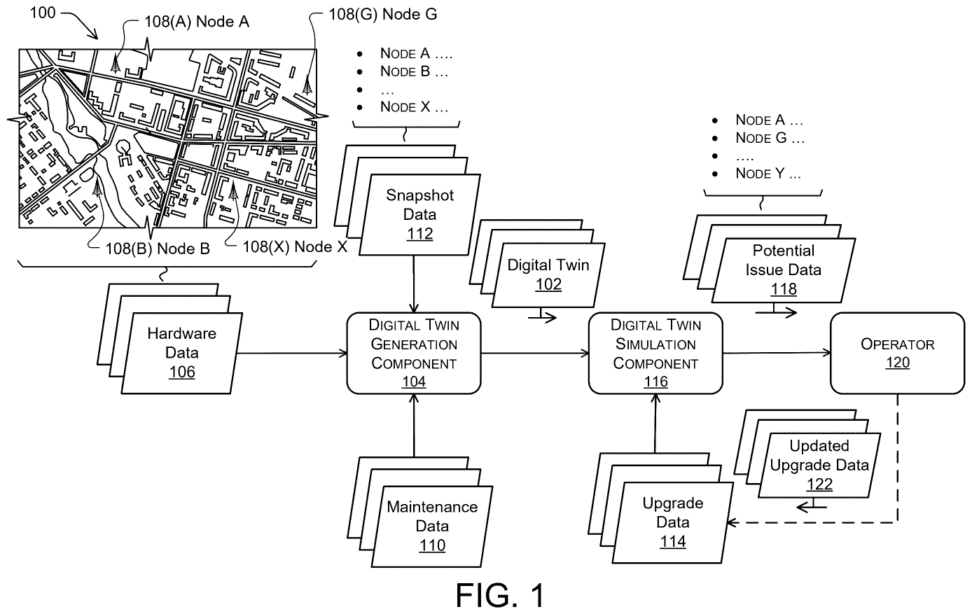

FIG. 1 is an example block diagram of a system 100 for generating a digital twin 102 of a network and executing simulations associated with the digital twin 102, according to some implementations. For example, in some instances, the network may be a wireless network, a telecommunications network, cellular network, and/or the like. As discussed above, the system 100 may be configured to generate the digital twin 102 of a network including the particular features, characteristics, situation, and/or the like of each individual site and/or equipment of the network. For example, the sites and/or equipment of the network may include, but are not limited to, access nodes components, base station components, radio access network components, edge network components, core network components, non-terrestrial network (NTN) components, cloud computing components, data storage components, and/or the like. The system 100 may also be configured to simulate installation or deployment of upgrades (e.g., software upgrades, hardware upgrades, new equipment installations, and/or the like) with respect to the network, individual sites of the network, particular hardware components associated with a site of the network, and/or the like utilizing the digital twin 102 prior to deployment on the physical hardware. In this manner, the system 100 may be utilized to determine or detect potential issues associated with the deployment of one or more upgrades prior to temporarily disabling a site during an installation window. Accordingly, the system 100 may be utilized to reduce downtime associated with hardware of the network.

In some cases, the system 100 may include a digital twin generation component 104. The digital twin generation component 104 may be configured to receive hardware data 106 including data associated with hardware installed at a plurality of nodes or sites associated with the network, such as nodes 108(A)-(X) as illustrated. In this manner, the digital twin generation component 104 may integrate the specific or individual hardware data associated with each of the nodes 108 (A)-(X), such that the digital twin generation component 104 may incorporate specific features, characteristics, operational components of each individual node 108.

The digital twin generation component 104 may also receive maintenance data 110 and snapshot data 112 associated with each of the plurality of nodes 108. In some cases, the maintenance data 110 may be received as a log or report of an operation performed on the physical hardware at a specific node or site 108 associated with the network. For example, maintenance personnel may upload or otherwise provide a log or report (e.g., maintenance data 110) to the system 100 following completion of one or more repair or maintenance operations performed on the specific site or node 108, such as overrated hardware, repaired hardware, and added or removed hardware, and/or the like. The snapshot data 112 may be captured by the network at predetermined intervals or periods (e.g., hourly, daily, weekly, monthly, and/or the like). In some cases, the snapshot data 112 may include operational data associated with each of the nodes of the network at the various predetermined interval. In this manner, the system 100 and the digital twin generation component 104 may receive operational data associated with hardware of each site or node 108 at each of the predetermined interval or periods of time.

The digital twin generation component 104 may then utilize the hardware data 106, the maintenance data 110, and the snapshot data 112 (e.g., for one or more intervals) to generate a digital twin 102 corresponding to the operational state of the network at the time that the snapshot was captured (e.g., at the predetermined interval). In some cases, the system 100 and the digital twin generation component 104 may generate multiple digital twins 102, each of the digital twins 102 representing a current state of the network at the predetermined interval. Accordingly, in some cases, the system 100 may simulate upgrades to the network at various intervals. For example, the system 100 simulate the deployment of the upgrade on the digital twin 102 corresponding to the current state of the network and determine one or more nodes 108 experience at least one issue. In this example, the system 100 may utilize a prior digital twin 102 associated with one or more prior snapshots 112 to determine if the upgrade would be successfully operational on a particular site or node 108 exploring the at least one issue. In this manner, the system 100 may be able to determine if a recent alteration or modification to the hardware at the particular node caused the potential deployment issue, thereby reducing debugging time.

In some cases, the system 100 may receive upgrade data 114 associated with a planned network upgrade (e.g., such as a software upgrade). The upgrade data 114 may be received by a digital twin simulation component 116. The digital twin simulation component 116 may execute or initiate a simulation of the network including deployment of the upgrade data 114 on one or more nodes 108 of the network for a period of time (e.g., an hour, a day, a week, a month, and/or the like). In this manner, the digital twin simulation component 116 may determine if the installation or deployment of the upgrade data 114 to the network causes one or more of the nodes 108 to experience operational issues and/or if one or more of the nodes 108 experience operational issues post deployment and during the period of time.

The digital twin simulation component 116 may generate potential issue data 118 associated with one or more of the nodes 108 (e.g., the nodes determined to experience and issue during or after deployment of the update). As discussed above, the digital twin summation component 116 may utilize one or more thresholds associated with normal operations or expected operations to determine if one or more of the nodes 108 may experience a potential issue 118 with respect to the deployment of the upgrade data 114. For instance, the digital twin summation component 116 may generate the one or more thresholds based at least in part on operational data determined prior to the deployment of the upgrade data 114 as well as based at least in part on an expected operational change, boost, or improvement associated with the upper data 114. In this manner, the one or thresholds may be specific for individual nodes 108.

In some situations, the digital twin session component 116 may determine a potential issue 118 with respect to one or more nodes 108, such as note A, note G, and node Y in the illustrated example. In these situations, the potential issue data 118 may be provided to an operator 120, such as a debugging engineer or the like, to determine a cause of the potential issue 118 with respect to the individually identified nodes 108. In some cases, the operator 120 may modify the upgrade data to generate updated upgrade data 122, which may be provided to the digital simulation component 116 for further testing to determine if the updated upgraded data 122 allows the identified nodes 108 to operate within the one or more thresholds.

As discussed above, either or both of the digital twin generation component 104 and/or the digital twin simulation component 116 may utilize one or more machine learning models to generate the digital twin 102 and/or execute one or more simulations associated with the network based on the digital twin 102 of the network.

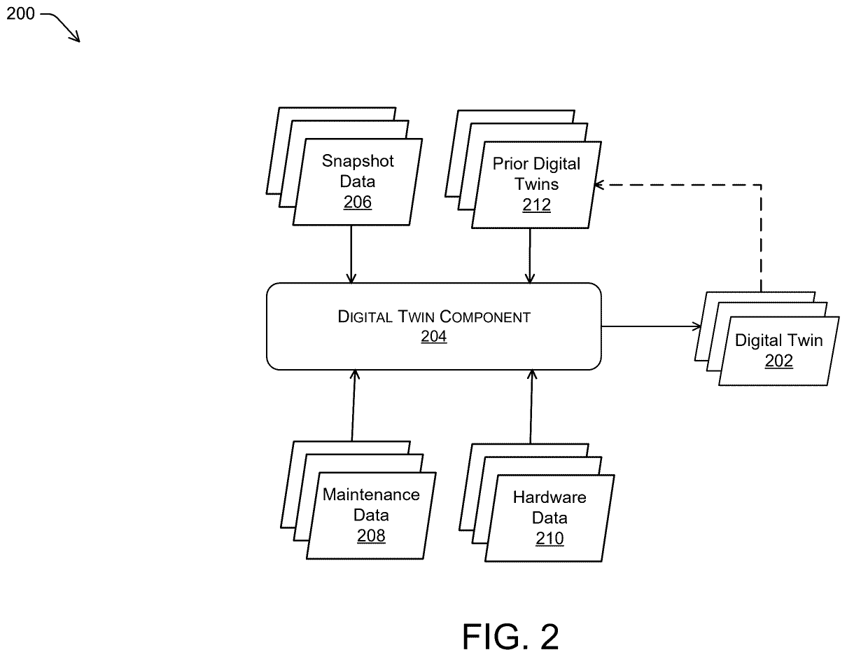

FIG. 2 is another example block diagram of a system 200 for generating a digital twin 202 of a network, according to some implementations. As discussed above, the system 200 may be configured to generate the digital twin 202 of a network including the particular features, characteristics, situation, and/or the like of each individual site and/or equipment. The digital twins 202 may then be utilized to simulate installation or deployment of upgrades (e.g., software upgrades, hardware upgrades, new equipment installations, and/or the like) with respect to the network, individual sites of the network, particular hardware components associated with a site of the network, and/or the.

In some cases, the system 200 may include a digital twin component 204 configured to generate and/or maintain the digital twin 202 representing the network or a portion of the network (e.g., the system 200 may maintain different digital twins 202 representing different geographical regions or portions of the network, such as portions that are typically upgraded in tandem). Accordingly, the digital twin component 204 may maintain one or more digital twins 202 over time.

In the current example, the digital twin component 204 may be configured to receive snapshot data 206, maintenance data 208, and hardware data 210 including data associated with hardware installed at a plurality of nodes or sites associated with the network. In this manner, the digital twin generation component 104 may integrate the specific or individual digital twins 202 for each of the nodes as well as for the larger portions of the network (e.g., multiple nodes operating in conjunction with each other).

The digital twin component 204 may then utilize the snapshot data 206, maintenance data 208, and hardware data 210 as well as one or more prior digital twins 212 to maintain a state or status of the digital twin 202. In this manner, the digital twin component 204 may update existing digital twins 202 with any data representing a change or alteration to one or more of the nodes, such as a repair operation and/or the like.

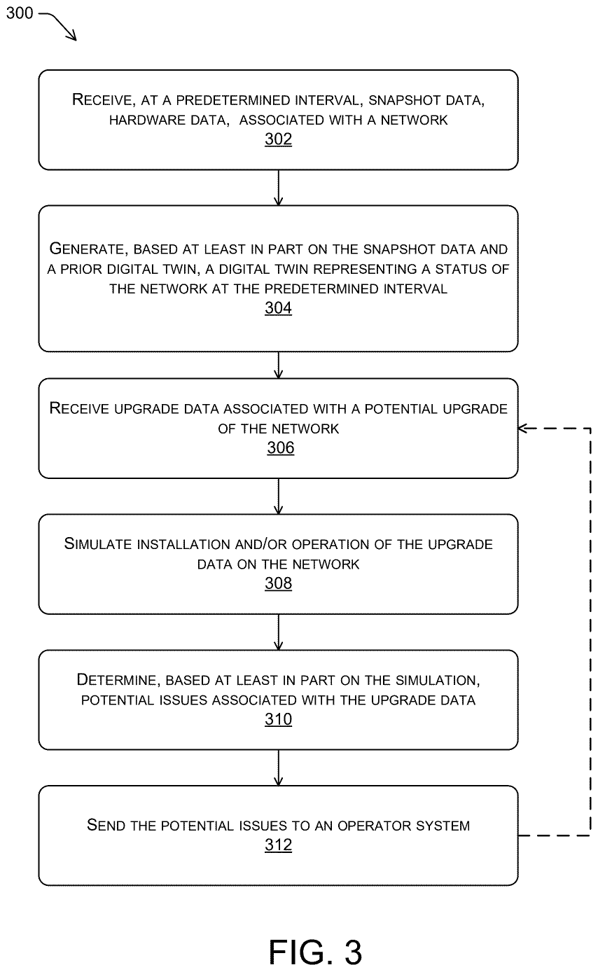

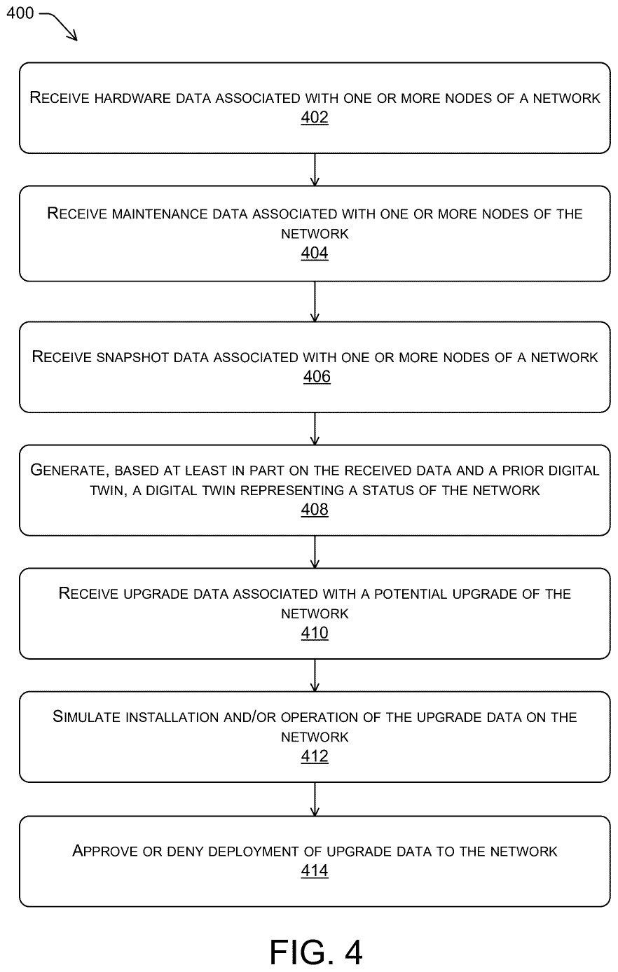

FIGS. 3 and 4 are flow diagrams illustrating example processes associated with the system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 3 is a flow diagram illustrating an example process 300 associated with a system for evaluating upgrade deployments using a digital twin of a network, according to some implementations. As discussed above, a system may be configured to generate the digital twin of a network including the particular features, characteristics, situation, and/or the like of each individual site and/or equipment. The system may also be configured to simulate installation and/or deployment of upgrades (e.g., software upgrades, hardware upgrades, new equipment installations, and/or the like) with respect to the network, individual sites of the network, particular hardware components associated with a site of the network, and/or the like utilizing the digital twin prior to deployment on the physical hardware. In this manner, the system may be utilized to determine or detect potential issues associated with the deployment of one or more upgrades prior to temporarily disabling a site during an installation window. Accordingly, the system may be utilized to reduce downtime associated with hardware of a network, such as a wireless network, a telecommunications network, cellular network, and/or the like.

At 302, the system may receive, at a predetermined interval, snapshot data associated with a network. For example, the system may receive the snapshot data associated with operations of the network at or on various hardware components, at various sites or nodes associated with the network, between hardware at various sites or nodes, and/or the like. Some cases snapshot data may include consumption data, throughput data, bandwidth data, jitter data, signal-to-noise ratio data, received signal strength indicator data, coverage area data, packet loss data, error rate data, interference data, and/or the like.

At 304, the system may generate, based at least in part on the snapshot data and a prior digital twin, a digital twin representing a status of the network at the predetermined interval. For example, the system may utilize one or more machine learning models configured to receive as an input the snapshot data and the prior digital twin and to output an updated digital twin representing the current status of the network.

At 306, the system may receive upgrade data associated with a potential upgrade of the network. For example, the upgrade data may include software updates such as firmware updates, performance updates, security updates, patches, feature updates, hotfixes, and/or the like.

At 308, the system may simulate installation and or operation of the upgrade data on the network. For example, the simulation may be associated with specific nodes or sites of the network, specific hardware components of the network and/or of specific nodes or sites of the network, a region or portion of the network (e.g., such as each node in a geographic region and/or the like). In some cases, the system may determine metrics associated with the performance and/or operation of the portion of the network being tested following the deployment or installation of the upgrade data. In some examples, the system may be configured to compare the metrics with various thresholds, past performance of the network, and or expected performance of the network.

At 310, the system may determine, based at least in part on the simulation, potential issues associated with the upgrade data. For example, if the system determines that the metrics output by the simulation failed to meet one or more criteria, e.g., failed to meet one or more thresholds, performed in a manner that fails to meet or exceed past performance data were expected performance data, resulted in unexpected outcomes, and/or the like that the upgrade data may introduce potential issues when deployed on the physical system.

In some cases, the potential issues may be associated with particular nodes or sites of the network and/or particular hardware components of the network. In these cases, the system may identify particular nodes or sites and/or hardware components related to the potential issues. The system may then approve or greenlight deployment of the upgrade data to various nodes of the network and/or to various hardware components of the network that were not identified with respect to the potential issue while delaying or halting deployment of the upgrade data to the particular nodes and/or hardware components associated with the potential issues. In this manner the system may allow for deployment of the upgrade on a case-by-case basis or site by site basis.

At 312, the system may send the potential issues to an additional system, such as an operator system. The system may send the list of potential issues, any generated metrics associated with the upgrade data, a list of any associated sites or nodes as well as a list of any equipment components associated with the potential issues. In this manner, an engineer and/or the additional system may assist in determining a cause of the issue or otherwise debugging the potential issue. In some cases, the engineer and/or the additional system may generate updated upgrade data for the system to test and/or simulate the deployment of until a successful upgrade is identified. Accordingly, the system discussed herein may reduce operational downtime associated with failed deployments.

In some specific examples, the system may identify particular hardware components at one or more sites or nodes for replacement or maintenance operations. For example, in some cases, the potential issue may be associated with hardware rather than the upgrade data. In these cases, the system may send the potential issue to a repair personal with instructions to perform one or more repair or maintenance operations on the identified hardware, site or node.

FIG. 4 is another flow diagram illustrating an example process 400 associated with a system for evaluating upgrade deployments using a digital twin of a network, according to some implementations. As discussed above, a system may be configured to generate the digital twin of a network including the particular features, characteristics, situation, and/or the like of each individual site and/or equipment. The system may also be configured to simulate installation and/or deployment of upgrades (e.g., software upgrades, hardware upgrades, new equipment installations, and/or the like) with respect to the network, individual sites of the network, particular hardware components associated with a site of the network, and/or the like utilizing the digital twin prior to deployment on the physical hardware. In this manner, the system may be utilized to determine or detect potential issues associated with the deployment of one or more upgrades prior to temporarily disabling a site during an installation window. Accordingly, the system may be utilized to reduce downtime associated with hardware of a network, such as a wireless network, a telecommunications network, cellular network, and/or the like.

At 402, the system may receive hardware data associated with one or more nodes of the network. For example, the system may receive data associated with hardware installed at each of the one or more nodes of the network, such as equipment type, age, capabilities, characteristics, features, and/or the like.

At 404, the system may receive maintenance data associated with the one or more nodes of the network. For example, the system may receive data associated with repair operations performed at each of the one or more networks, such as repair outages, hardware equipment and hardware component replacement, hardware equipment or component damage, and/or the like.

At 406, the system may receive, such as at a predetermined interval, snapshot data associated with the network. For example, the system may receive the snapshot data associated with operations of the network at or on various hardware components, at various sites or nodes associated with the network, between hardware at various sites or nodes, and/or the like. In some cases, snapshot data may include consumption data, throughput data, bandwidth data, jitter data, signal-to-noise ratio data, received signal strength indicator data, coverage area data, packet loss data, error rate data, interference data, and/or the like.

At 408, the system may generate, based at least in part on the received data and a prior digital twin, a digital twin representing a status of the network at the predetermined interval. For example, the system may utilize one or more machine learning models configured to receive as an input the snapshot data and the prior digital twin and to output an updated digital twin representing the current status of the network.

At 410, the system may receive upgrade data associated with a potential upgrade of the network. For example, the upgrade data may include software updates such as firmware updates, performance updates, security updates, patches, feature updates, hotfixes, and/or the like.

At 412, the system may simulate installation and or operation of the upgrade data on the network. For example, the simulation may be associated with specific nodes or sites of the network, specific hardware components of the network and/or of specific nodes or sites of the network, a region or portion of the network (e.g., such as each node in a geographic region and/or the like). In some cases, the system may determine metrics associated with the performance and/or operation of the portion of the network being tested following the deployment or installation of the upgrade data. In some examples, the system may be configured to compare the metrics with various criteria, such as thresholds, past performance of the network, and/or expected performance of the network.

At 414, the system may approve or deny deployment of the upgrade data to the network. For example, the system may approve or deny the deployment of the upgrade data to the network based at least in part on a comparison of operational data or determining metrics and the various thresholds, past performance of the network, and/or expected performance of the network.

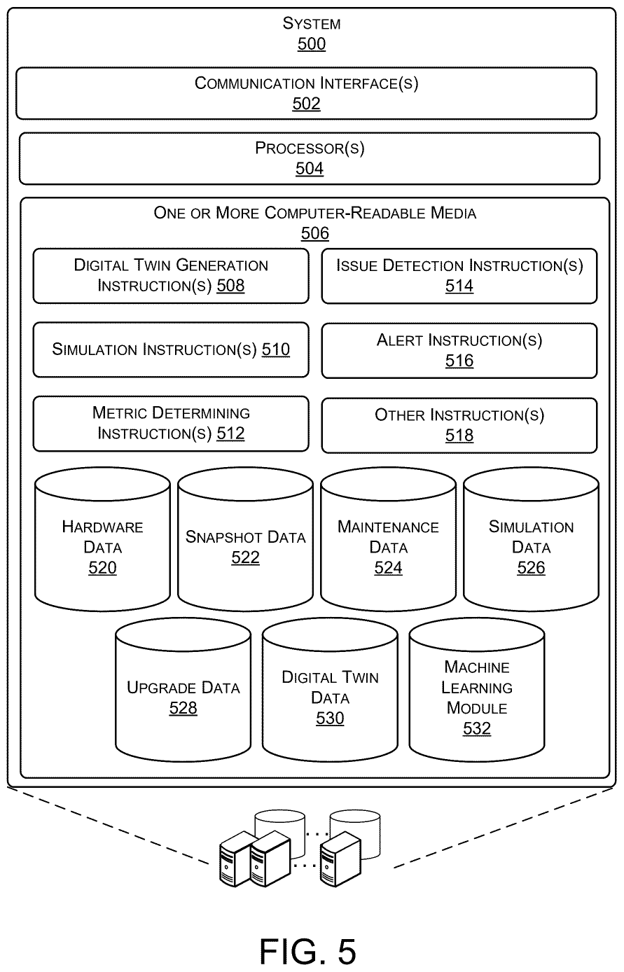

FIG. 5 is an example system 500 that may implement the techniques described herein according to some implementations. The system 500 may include one or more communication interface(s) 502 (also referred to as communication devices and/or modems), one or more processor(s) 504, and one or more computer readable media 506.

The system 500 may include one or more communication interfaces(s) 502 that enable communication between the system 500 and one or more other local or remote computing device(s) or remote services. For instance, the communication interface(s) 502 can facilitate communication with other central processing systems, a user device, or other third-party systems to receive and provide diagrams in various formats. The communications interfaces(s) 502 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The system 500 may include one or more processors 504 and one or more computer-readable media 506. Each of the processors 504 may itself comprise one or more processors or processing cores. The computer-readable media 506 is illustrated as including memory/storage. The computer-readable media 506 may include volatile media (such as random access memory (RAM)) and/or nonvolatile media (such as read only memory (ROM), Flash memory, optical disks, magnetic disks, and so forth). The computer-readable media 506 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Several modules such as instructions, data stores, and so forth may be stored within the computer-readable media 506 and configured to execute on the processors 504. For example, as illustrated, the computer-readable media 506 stores digital twin generation instructions 508, simulation instructions 510, metric determining instructions 512, issue detection instructions 514, alert instructions 516, as well as other instructions 518, such as an operating system. The computer-readable media 506 may also be configured to store data, such as hardware data 520, snapshot data 522, maintenance data 524, simulation data 526, upgrade data 528, digital twin data 530, one or more machine learning models 532 as well as other data.

The digital twin generation instructions 508 may be configured to receive the hardware data 520, snapshot data 522, and maintenance data 524 and utilizing the hardware data 520, snapshot data 522, and maintenance data 524 generate a digital twin of the network or a portion of the network (e.g., one or more sites or nodes) representing a status or state of the network or the portion of the network at the particular time.

In some cases, the maintenance data 524 may be received as a log or report of an operation performed on the physical hardware at a specific node or site associated with the network. For example, maintenance personnel may upload or otherwise provide a log or report (e.g., maintenance data 524) to the system 500 following completion of one or more repair or maintenance operations performed on the specific site or node, such as damaged hardware, repaired hardware, and added or removed hardware, and/or the like.

The snapshot data 522 may be captured by the network at predetermined intervals or periods (e.g., hourly, daily, weekly, monthly, and/or the like). In some cases, the snapshot data 522 may include operational data associated with each of the nodes of the network at the various predetermined interval. In this manner, the system 500 and the digital twin generation instructions 508 may receive operational data associated with hardware of each site or node at each of the predetermined interval or periods of time.

The digital twin generation instructions 508 may then utilize the hardware data 520, the maintenance data 524, and the snapshot data 522 (e.g., for one or more intervals) to generate a digital twin corresponding to the operational state of the network at the time that the snapshot was captured (e.g., at the predetermined interval). In some cases, the system 500 and the digital twin generation instructions 508 may generate multiple digital twins. In some cases, each of the digital twins represents a current state of the network at the predetermined interval.

The simulation instructions 510 may be configured to simulate upgrades (represented by upgrade data 528) to the network at various intervals using the digital twins. For example, the simulation instructions 510 simulate the deployment of the upgrade data 530 on the digital twin corresponding to the current state of the network and determine one or more nodes experience at least one issue. In this example, the simulation instructions 510 may utilize a prior digital twin associated with one or more prior snapshots to determine if the upgrade would be successfully operational on a particular site or node. In this manner, the simulation instructions 510 may generate simulation data 526 usable to determine if a current status or state of hardware at the particular node may cause a potential deployment issue, thereby reducing site or node downtime.

The metric determining instructions 512 may be configured to utilize the simulation data 526 two determine one or more metrics associated with the operation of the network with the portion of the network simulated either during or after deployment of the upgrade data 528. For example, the metric determining instructions 512 may determine performance related metrics associated with the operation of the network or a portion of the network following the simulated deployment of the upgrade data 528.

The issue detection instructions 514 may be configured to compare the one or more metrics determined by the metric determining instructions 512 with one or more thresholds associated with the operation of the network. In some cases, the issue detection instructions 514 may utilize one or more thresholds associated with prior performance of the network or the portion of the network, expected improvements to the performance of the network with the portion of the network, and/or the like. In some instances, if the issue detection instructions 514 determines that the network or a portion of the network fails to operate within the desired thresholds, the issue detection instructions 514 may flag or demark a potential issue associated with the network or a portion of the network for further review prior to deployment.

The alert instructions 516 may be configured to provide an alert to one or more engineers, automated systems, machine learning models or networks, and/or the like to further investigate each of the potential issues affected by the issue detection instructions 514. In some cases, the alert instructions 516 may generate temporary pauses or holds to deployment operations associated with the upgrade data 528.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving snapshot data associated with a network;
generating, based at least in part on the snapshot data, a digital twin representing a portion of the network;
receiving upgrade data, the upgrade data including a software update to be deployed to the portion of the network;
simulating, based at least in part via the digital twin, deployment of the upgrade data on the portion of the network;
determining a node of the portion of the network that failed to meet or exceed one or more criteria associated with the deployment of the upgrade data; and
responsive to determining the node failed to meet or exceed the one or more criteria, sending an alert associated with the node to a remote system.

2. The method of claim 1, further comprising:
receiving modified upgrade data;
simulating, based at least in part via the digital twin, deployment of the modified upgrade data on the portion of the network;
determining the node of the portion of the network meets or exceeds one or more criteria associated with the deployment of the upgrade data; and
approving the modified upgrade data for physical deployment.

3. The method of claim 1, wherein generating the digital twin representing the portion of the network further comprises:
inputting the snapshot data into one or more first machine learning models and receiving as an output of the one or more first machine learning models the digital twin representing the portion of the network.

4. The method of claim 1, wherein simulating the deployment of the upgrade data on the portion of the network further comprises:
inputting the digital twin and the upgrade data into one or more second machine learning models and receiving as an output of the one or more second machine learning models metric data associated with operations of the portion of the network.

5. The method of claim 4, wherein determining the node of the portion of the network failed to meet or exceed the one or more criteria associated with the deployment of the upgrade data further comprises:
determining, based at least in part on the metric data associated with operations of the portion of the network, the node of the portion of the network failed to meet or exceed the one or more criteria associated with the deployment of the upgrade data.

6. The method of claim 4, wherein the snapshot data further comprises one or more of:
available bandwidth associated with the portion of the network;
throughput associated with the portion of the network;
signal strength associated with the portion of the network;
signal-to-noise ratios associated with the portion of the network;
received signal strength indicators associated with the portion of the network;
coverage area associated with the portion of the network;
latency associated with the portion of the network;
jitter associated with the portion of the network;
packet loss associated with the portion of the network;
error rates associated with the portion of the network; or
interference associated with the portion of the network.

7. The method of claim 1, wherein generating the digital twin representing the portion of the network is based at least in part on hardware data associated with hardware installed at one or more nodes of the network.

8. The method of claim 1, wherein generating the digital twin representing the portion of the network is based at least in part on maintenance data associated with repair operations to hardware associated with the portion of the network.

9. A system comprising:
one or more processors;
one or more communication interfaces; and
one or more computer-readable media storing instructions that, when executed by the one or more processors, cause the one or more processors to perform operations comprising:
receiving snapshot data associated with a network;
generating, based at least in part on the snapshot data, a digital twin representing a portion of the network, the portion including two or more sites of the network;
receiving upgrade data, the upgrade data to be deployed to the portion of the network;
simulating, based at least in part via the digital twin, deployment of the upgrade data on the portion of the network; and
sending, based at least in part on results of simulating the deployment of the upgrade data on the portion of the network, an approval to deploy the upgrade data to the two or more sites.

10. The system of claim 9, wherein generating the digital twin representing the portion of the network is based at least in part on hardware data associated with hardware installed at the two or more sites and on maintenance data associated with repair operations to hardware associated with the two or more sites.

11. The system of claim 9, wherein the approval includes a first approval for a first site of the two or more sites and a second approval for a second site of the two or more sites, the first approval sent to a first device and the second approval sent to a second device different than the first device.

12. The system of claim 9, wherein the digital twin is a second digital twin, the two or more sites of the network are a first two or more sites of the network, and the instructions when executed by the one or more processors, cause the one or more processors to perform additional operations comprising:
receiving second snapshot data associated with two or more second sites of the network, the two or more second sites of the network different than the first two or more sites of the network;
generating, based at least in part on the second snapshot data, a second digital twin representing a second portion of the network, the second portion including the two or more second sites;
simulating, based at least in part via the second digital twin, deployment of the upgrade data on the second portion of the network; and
sending, based at least in part on results of simulating the deployment of the upgrade data on the portion of the network, an order to halt deployment of the upgrade data to at least one of the two or more second sites.

13. The system of claim 9, wherein the digital twin is a second digital twin, the two or more sites of the network are a first two or more sites of the network, and the instructions when executed by the one or more processors, cause the one or more processors to perform additional operations comprising:
receiving second snapshot data associated with two or more second sites of the network, the two or more second sites of the network different than the first two or more sites of the network;
generating, based at least in part on the second snapshot data, a second digital twin representing a second portion of the network, the second portion including the two or more second sites;
simulating, based at least in part via the second digital twin, deployment of the upgrade data on the second portion of the network; and
sending, based at least in part on results of simulating the deployment of the upgrade data on the portion of the network, an approval to deploy of the upgrade data to at least one of the two or more second sites.

14. One or more computer-readable media storing instructions that, when executed by one or more processors, cause the one or more processors to perform operations comprising:
receiving snapshot data associated with a network;
generating, based at least in part on the snapshot data, a digital twin representing a portion of the network;
receiving upgrade data, the upgrade data including a software update to be deployed to the portion of the network;
updating, based at least in part on the upgrade data, the digital twin;
determining, based at least in part by simulating operations of the portion of the network via the digital twin, a potential issue with a deployment of the upgrade data to the portion of the network; and
sending an alert associated with the potential issue to a remote system.

15. One or more computer-readable media of claim 14, wherein determining the potential issue with the deployment of the upgrade data to the portion of the network further comprises:
determining, by simulating operations of the portion of the network via the digital twin, metric data associated with operations of the portion of the network; and
determining that at least a portion of the metric data failed to meet or exceed one or more criteria associated with the deployment of the upgrade data.

16. One or more computer-readable media of claim 14, wherein the operations further comprise:
receiving modified upgrade data;
generating, based at least in part on the modified upgrade data, a modified digital twin;
determining, based at least in part by simulating operations of the portion of the network via the modified digital twin, that the portion of the network will perform within one or more expected thresholds; and
approving the modified upgrade data for physical deployment.

17. One or more computer-readable media of claim 16, wherein the remote system is associated with one or more of:
a personnel associated with the physical deployment of the upgrade data;
an automated system associated with debugging the upgrade data; or
a personnel associated debugging the upgrade data.

18. One or more computer-readable media of claim 16, wherein the data includes snapshot data of the portion of the network captures at predetermined intervals.

19. One or more computer-readable media of claim 16, wherein the snapshot data includes at least two snapshot of the portion of the network, the at least two snapshots including a first snapshot captured at a first predetermined interval and a second snapshot captured at a second predetermined interval prior to the first predetermined interval.

20. One or more computer-readable media of claim 14, generating the digital twin representing the portion of the network is based at least in part on hardware data associated with hardware installed at one or more nodes of the network and maintenance data associated with repair operations to hardware associated with the portion of the network.
